(19) United States
(12) Patent Application Publication
(10) Pub. No.: US 2026/0264507 A1
(43) Pub. Date: Sep. 10, 2026

(54) VALVE ASSEMBLY FOR A FUEL GAS TANK, FUEL GAS TANK COMPRISING A VALVE ASSEMBLY, AND FUEL GAS TANK SYSTEM

(71) Applicant: Robert Bosch GmbH, Stuttgart (DE)

(72) Inventor: Andreas Koeninger, Neulingen-Goebrichen (DE)

(21) Appl. No.: 19/165,360

(22) PCT Filed: Mar. 12, 2024
(86) PCT No.: PCT/EP2024/056529

§ 371 Date: Oct. 21, 2025

(30) Foreign Application Priority Data
Mar. 21, 2023 (DE) 10 2023 202 528.0

(51) Int. Cl. B60K 15/03

(52) U.S. Cl. CPC B60K 15/03006; B60K 2015/03026

(57) ABSTRACT

The invention relates to a valve assembly (1) for a fuel gas tank (2), comprising a housing (3) in which a refueling path (7) having an integrated non-return valve (8) is formed, wherein the non-return valve (8) comprises an axially movable valve element (11) and a closing spring (9), the spring force of which acts on the valve element (11) in the direction of a valve seat (10). According to the invention, in the region of the non-return valve (8), preferably in the housing (3) and/or in the valve element (11), a throttle and stop element (17) is integrated which has a defined throttle cross-section (A) for setting the gas mass flow in the refueling path (7) and a defined height dimension (h) for setting the lift (H) of the valve element (11).

The invention also relates to a fuel gas tank (2) and to a fuel gas tank system.

### BACKGROUND

The invention relates to a valve assembly for a fuel gas tank. The invention further relates to a fuel gas tank and a valve assembly according to the invention and a fuel gas tank system. The fuel gas may in particular be hydrogen or natural gas that is stored in a fuel gas tank under pressure.

Preferred areas of application of the invention are fuel cell and/or gas vehicles, that are driven with the aid of fuel gas.

Mobile fuel gas tank systems having at least one fuel gas tank for storing fuel gas, for example hydrogen or natural gas, are known. The fuel gas tank is typically configured as a high-pressure tank. Tank valves are typically screwed onto these tanks, via which refueling with fuel gas and the removal of fuel gas are controlled. Therefore, two gas paths are formed within the tank valve, a refueling path and a removal path. The tank valve may have its own high-pressure port for each path, or a common high-pressure port. In the latter case, with the aid of a valve, the two paths are then connected to each other in such a way that the refueling path or the removal path is connected to the high-pressure port, depending on the switching state.

A non-return valve is typically integrated in the refueling path to prevent hydrogen from escaping the fuel gas tank uncontrolled during system shutdown and in the event of removal. The non-return valve is typically configured as a mechanical non-return valve having an axially movable valve element and a helical compression spring, the spring force of which acts on the valve element in the direction of a valve seat. The non-return valve opens when a positive pressure is established in the refueling path upstream of the non-return valve against the pressure in the fuel gas tank so that a pneumatic opening force opposite the spring force of the helical spring acts on the valve element that is at least equal to the spring force.

When designing the non-return valve, the following must generally be observed:

The locking force of the spring must be sufficient to keep the non-return valve securely closed in the closed position even in the event of removal, since pressure is built up for tank valves with only one high-pressure connection not only in the removal path but also in the fueling path so that the non-return valve can open undesirably.

The stroke of the valve element should be as large as possible in order to enable optimum de-throttling and thus a high mass flow as well as short fueling times when the non-return valve is open.

With the non-return valve open, however, there may be an axial oscillation of the valve element due to system-immanent pressure oscillations, so-called “rattling”. The rattling, in turn, leads to increased wear on the guide and unwanted noise. In order to avoid this, a design goal is to stably adjust a pneumatic excess of force compared to the retaining force of the spring.

This is counteracted by the fact that during refueling, the back pressure in the fuel gas tank continuously increases and, as a result, the excess pneumatic force acting in the direction of opening decreases. This is further opposed by the fact that when a helical compression spring is used, the mechanical closing force increases with increasing opening stroke of the valve element due to the linear force characteristic of the helical compression spring.

In addition, in a fuel gas tank system with several differently sized fuel gas tanks, each equipped with its own tank valve, the technically maximum possible de-throttling of the fueling paths is directed towards the largest fuel gas tank, since it requires the longest filling time. If the fueling paths of the smaller fuel gas tanks were to be de-throttled as much as possible, this would lead to a faster filling of the smaller fuel gas tanks. This is not intentional, but rather the result of filling all fuel tanks as quickly and evenly as possible. To this end, throttle elements are integrated into the fueling paths of the smaller fuel gas tanks—upstream or downstream of the non-return valves.

Regardless of the positioning of a throttle element integrated in a fueling path, this reduces the gas mass flow in the fueling path. The result is a lower pneumatic force acting on the valve element of the non-return valve in the opening direction. Depending on the spring force setting, the necessary excess force may then be lacking in order to fully open or keep the non-return valve open or to prevent axial swing of the valve element.

In addition, the smaller fuel gas tanks of a fuel gas tank system with differently sized fuel gas tanks do not generally require a large valve lift design derived from the de-throttling requirements of the fueling path of the largest fuel gas tank, since the narrowest flow cross-section is pre-determined by the throttle element.

To remedy this, the tank size could be considered in the non-return valve design, particularly with respect to seat diameter, spring force and/or stroke. For each tank size, however, a different non-return valve would then have to be kept in stock, which would not be economical due to the large number of tank sizes.

### SUMMARY

With the help of the present invention, the aforementioned disadvantages are to be overcome or at least reduced. In particular, an economical solution to optimize the design of a non-return valve integrated into a fueling path, including the respective tank size, is to be found in order to prevent undesirable axial oscillation of the valve element of the non-return valve.

Proposed in order to achieve the object of the invention is the valve assembly having the features of the disclosure. Furthermore, a fuel gas tank with a valve assembly according to the present invention and a fuel gas tank system are proposed.

The valve assembly proposed for a fuel gas tank includes a housing in which a fueling path with an integrated non-return valve is formed. The non-return valve is configured as an axially movable valve element and a closing spring, the spring force of which acts on the valve element in the direction of a valve seat. According to the invention, in the region of the non-return valve, preferably in the housing and/or in the valve element, a throttle and stop element is integrated which has a defined throttle cross-section for setting the gas mass flow in the refueling path and a defined height dimension for setting the lift of the valve element.

The throttle and stop element constitutes a simple and cost-efficient component to be manufactured, so that several throttle elements and stop elements with different throttle cross-sections and/or height dimensions result in a cost-effective modular system. This modular system allows the throttle and stop element suitable for the respective tank size to be selected when designing the non-return valve. A throttle element and stop element is considered to be “suitable” in particular if it ensures a stable lift stop of the valve element during fueling of the fuel gas tank, so that it does not begin to vibrate axially.

Thanks to the modular system, it is no longer necessary to keep a variety of different non-return valves in stock, but rather—with the exception of the throttle and stop element—the same components can be used. This reduces overall costs.

Further simplification and cost reduction is achieved by using the throttle and stop element to combine several functions in one component, namely the adjustment of the gas mass flow in the fueling path and the adjustment of the valve lift.

Advantageously, the throttle and stop element is arranged in the fueling direction downstream of the valve element of the non-return valve. The closing spring is also generally arranged on this side, so that—depending on the specific design of the non-return valve, the throttle and stop element can be used as a spring plate. In the case of a closing spring configured as a helical compression spring, the space between the windings can also be used to receive the throttle and stop element at least in sections, so that the installation space requirements of the non-return valve remain substantially unchanged.

Preferably, the defined throttle cross-section is formed by at least one bore, groove and/or recess of the throttle and stop element. In the case of a bore, fuel gas flows through the throttle and stop element (internal flow configuration). In the case of a groove and/or recess, the throttle and stop element is surrounded by the fuel gas (external flow design). The housing of the valve assembly can then be used to further limit the throttle cross-section, such that the throttle and stop element together with the housing forms a defined throttle cross-section.

According to a preferred embodiment of the invention, the throttle and stop element is inserted, preferably pressed, into the housing of the valve assembly, and has an end face facing the valve element serving as a lift stop. The throttle and stop element thus forms a fixed lift stop where the valve element ideally remains in place during a fueling operation. The throttle and stop element inserted into the housing moves the lift stop closer to the valve element, allowing the valve stroke to be adjusted via the height dimension of the throttle and stop element.

According to a further preferred embodiment of the invention, the throttle and stop element is at least inserted, preferably pressed, into the valve element in sections and has an end face facing away from the valve element, which cooperates with a housing-side lift stop. The housing-side lift stop may be formed, for example, by a shoulder of the housing. Thus, in this embodiment, the lift stop is stationary. The throttle and stop element integrated into the valve element shortens the distance between the lift stop and the valve element, so that the valve lift is adjustable via the height dimension of the throttle and stop element.

Furthermore, it is proposed that the throttle and stop element be arranged in a stepped fashion. The height dimension of the throttle and stop element can be easily specified using the step. Further, a connection portion can be created that can be inserted, in particular pressed, into a bore of the housing or the valve element. In the latter case, the connection portion has a press fit with respect to the bore. The step can then be used to specify the press-in depth of the valve element.

Alternatively or additionally, a support surface for supporting the closing spring can be configured via the step.

Furthermore, the throttling and stop element preferably has at least one flattened area on its outer circumference, for example in the form of a bevel. This embodiment of the throttle and stop element is particularly advantageous when the throttle and stop element is surrounded by the fuel gas (external flow design), so that the fuel gas can reach the throttle point via the external flattened section.

In a further development of the invention, it is proposed that the housing of the valve assembly comprises a connection portion for connection to the fuel gas tank and a connection portion for connection to at least one high-pressure connection line. The connection portion can in particular be cylindrical in shape, so that it can be easily inserted into a fuel gas tank, preferably into a bottle neck of a bottle-shaped fuel gas tank. The connection portion of the housing is preferably arranged outside of the fuel gas tank, so that it can be easily connected to the at least one high-pressure connection line.

Since the preferred area of application for a valve assembly according to the present invention is fuel gas tanks, a fuel gas tank with a valve assembly according to the present invention is also proposed. The housing of the valve assembly is preferably inserted, in particular screwed, into the fuel gas tank in sections, preferably in a bottle neck of the fuel gas tank.

Furthermore, a fuel gas tank system is proposed which comprises at least one fuel gas tank having a valve assembly according to the invention as a tank valve. Preferably, the fuel gas tank system comprises a plurality of parallel connected fuel gas tanks, at least one of which is equipped with a valve assembly according to the present invention. The storage capacity of the fuel gas tank system can be adjusted to suit specific requirements by varying the number of fuel gas tanks. Furthermore, the fuel gas tanks are preferably designed in different sizes in order to make optimum use of the available installation space. In this case, at least the smallest fuel gas tank has a valve assembly according to the invention as a tank valve.

Preferred areas of application of a fuel gas tank system according to the present invention are fuel cell vehicles and/or gas vehicles.

### BRIEF DESCRIPTION OF THE DRAWINGS

A preferred embodiment of the invention is explained in more detail below with reference to the accompanying drawings. Shown are:

FIG. 1 a schematic longitudinal section through a valve assembly on a fuel gas tank according to the invention,

FIG. 2 a schematic longitudinal section through a first non-return valve for a valve assembly a) according to the invention in the closed position and b) in the open position,

FIG. 3 a schematic longitudinal section through a second non-return valve for a valve assembly according to the invention a) in the closed position and b) in the open position,

FIG. 4 a schematic longitudinal section through a third non-return valve for a valve assembly according to the invention a) in the closed position, b) in the open position and c) a schematic cross-section through the non-return valve,

FIG. 5 a schematic illustration of a fuel gas tank system having fuel gas tanks of different sizes.

### DETAILED DESCRIPTION

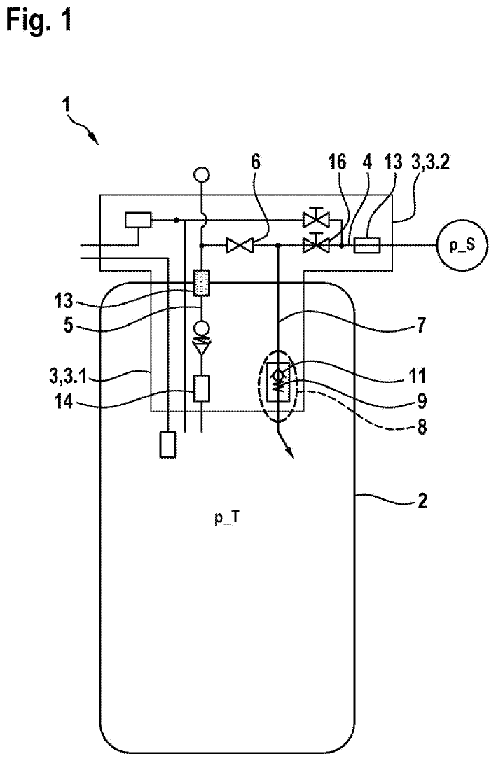

The valve assembly 1 according to the invention shown schematically in FIG. 1 comprises a housing 3 with a connection portion 3.1 and a connection portion 3.2. The valve assembly 1 is inserted into fuel gas tank 2 via the connecting portion 3.1. A high-pressure connection line 15 is connected to the valve assembly 1 via the connection portion 3.2. The valve assembly 1 shown serves to remove fuel gas from the fuel gas tank 2 and to fill the fuel gas tank 2 with fuel gas. The fuel gas may in particular be hydrogen or natural gas.

A removal path 5 with an integrated shut-off valve 6 is configured in the housing 3 of the valve assembly 1 to remove fuel. Fueling of fuel gas tank 2 is carried out via a fueling path 7 with an integrated non-return valve 8. The removal path 5 and the fueling path 7 are merged in sections to form a fuel gas path 4 to which the high-pressure connection line 15 is connected.

In addition to the valves already mentioned, a manually actuatable valve 16 is integrated in the fuel gas path 4. Further valves are provided in the removal path 5, among other things a mass flow limiting valve 14. A filter 13 is also arranged in the removal path 5 between the mass flow limiting valve 14 and the shut off valve 6. Another filter 13 is integrated into the fuel gas path 4. In addition, further devices are provided, in particular safety devices and sensors.

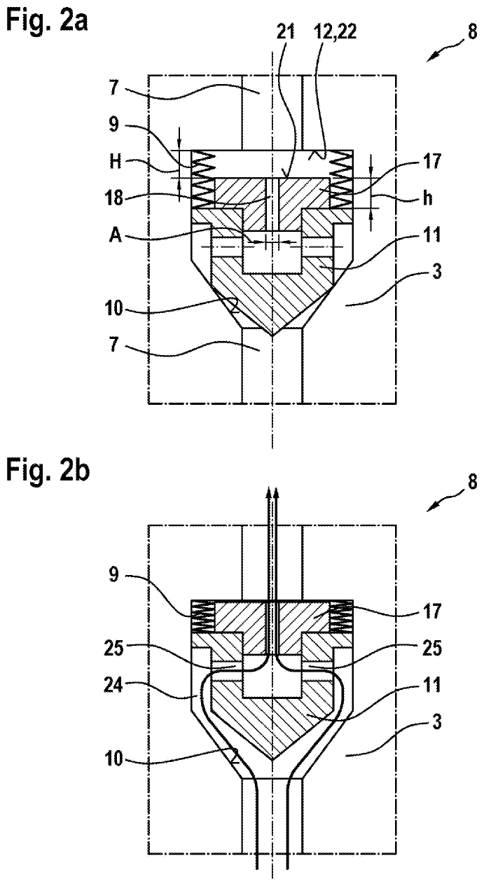

An essential element of a valve assembly 1 according to the present invention is a throttle and stop element 17, which is integrated in the region of the non-return valve 8 into the housing 3 or in the valve element 11 of the non-return valve 8. Possible embodiments of the throttle and stop element 17 are described below with reference to FIGS. 2, 3 and 4, each showing a non-return valve 8 accommodated in a housing 3 of a valve assembly 1.

In the non-return valve 8 of FIG. 2a), b), the housing 3 forms a valve seat 10 for an axially movable valve element 11, which is acted upon in the direction of the valve seat 10 by the spring force of a closing spring 9. The throttle and stop element 17 is partially inserted, in particular pressed, into the valve element 11, in such a way that it moves together with the valve element 11. Due to its stepped design, the throttle and stop element 17 forms a circumferential surface or step which, when the throttle and stop element 17 is inserted, in particular pressed in, comes into contact with the valve element 11, so that the press-in depth of the throttle and stop element 17 in relation to the valve element 11 can be predetermined. At the same time, a defined height dimension h of the throttle and stop element 17 is predetermined by the step by means of which the stroke H of the valve element 11 is adjustable. At full stroke H, an end face 21 of the throttle and stop element 17 comes into contact with a lift stop 12 on the housing side, which in this case is formed by a shoulder 22 of the housing 3. A defined throttle cross-section A is also specified via a bore 18 formed in the throttle and stop element 17.

In FIG. 2a), the non-return valve 8 is closed so that no fuel gas can escape from the fuel gas tank (not shown) via the fueling path 7.

In FIG. 2b), the non-return valve 8 is fully open so that fuel gas can enter a valve space 24 via the valve seat 10 and from there via radial bores 25 formed in the valve element 11 to the bore 18 of the throttle and stop element 17 (see arrows in FIG. 2b)). Fuel gas flows through the throttle and stop element 17 (internal flow configuration).

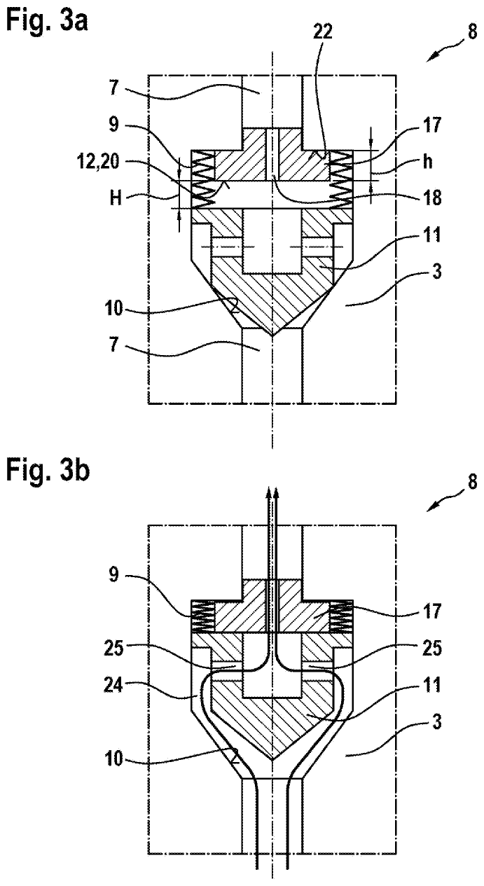

In the non-return valve 8 of FIG. 3a), b), the throttle and stop element 17 is not connected to the valve element 11 but to the housing 3. Incidentally, the non-return valve 8 of FIG. 3a), b) is constructed in the same way as FIG. 2a), b).

In FIG. 3a), b), the throttle and stop element 17 are designed in a stepped fashion and inserted, in particular pressed, into a bore 26 of the housing 3 in sections. The step provides the pressing depth on the one hand, and on the other hand a defined height dimension h of the throttle and stop element 17. An end face 20 of the throttle and stop element 17 facing the valve element 11 forms a lift stop 12 against which the valve element 11 comes to rest when it has completed its full stroke H.

In FIG. 3a), the non-return valve 8 is closed so that no fuel gas can escape from the fuel gas tank (not shown) via the fueling path 7.

In FIG. 3b), the non-return valve 8 is fully open so that fuel gas can enter a valve space 24 via the valve seat 10 and from there via radial bores 25 formed in the valve element 11 to the bore 18 of the throttle and stop element 17 (see arrows in FIG. 3b)). Fuel gas flows through the throttle and stop element 17 (internal flow configuration).

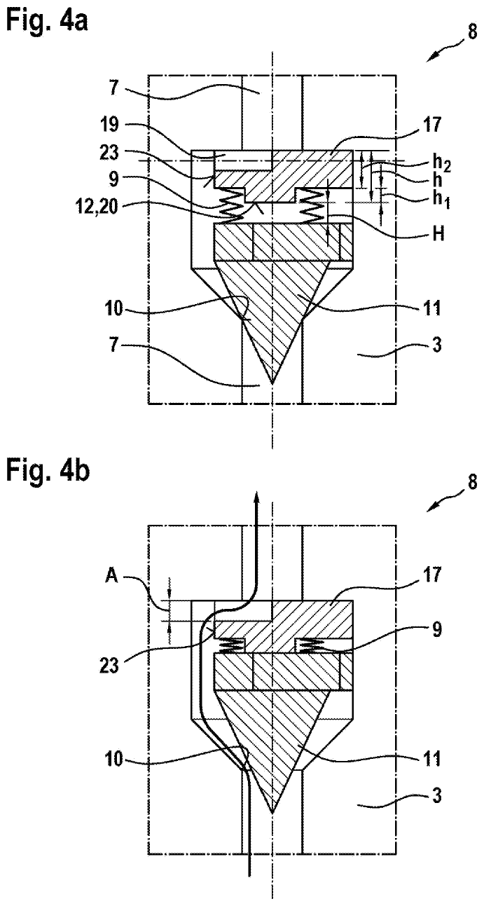

With the non-return valve 8 of FIG. 4a), b), c), the throttle and stop element 17 is designed such that the fuel gas is guided outside of the throttle and stop element 17 (external flow design). The throttle and stop element 17 comprise a recess 19 arranged on the front side, which is limited on one side by the housing 3 so that the recess 19 has a defined throttle cross-section A. The throttle and stop element 17 is designed in a stepped fashion, so that a step is formed on which the closing spring 9 is supported in the present case. The step divides the throttle and stop element 17 into two sections, the heights of which h₁ and h₂ together give a defined height dimension H. An end face 20 of the throttle and stop element 17 facing the valve element 11 serves as a lift stop 12 against which the valve element 11 comes to rest when it has completed its full stroke H (see FIG. 4b).

Since the throttle and stop element 17 has an externally flowing configuration, outer circumferential flat portions 23 are provided for the formation of flow channels (see FIG. 4c) via which the fuel gas reaches the recess 19. The valve element 11 may have similar flat portions.

Not shown, but a further possible configuration of a non-return valve 8 for a valve assembly 1 according to the invention can be configured analogously to the non-return valve 8 of FIG. 4 and connected to the valve element 11 instead of the housing 3.

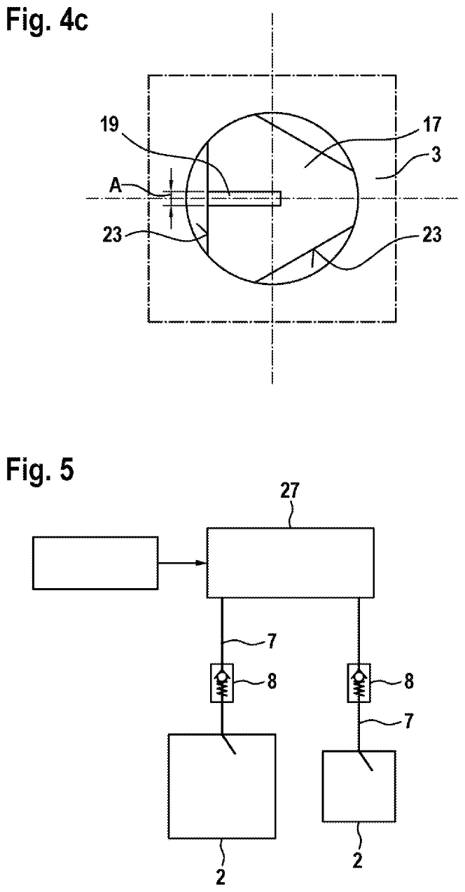

A preferred area of application of a valve assembly 1 according to the present invention is fuel gas tank systems having a plurality of fuel gas tanks 2 of different sizes. Such a fuel gas tank system is illustrated by way of example in FIG. 5, wherein the complete representation of the tank valves and valve assemblies 1 connected to the fuel gas tanks 3, has been omitted. Instead, only the fueling path 7 with the non-return valve 8 integrated herein is shown.

The fuel gas tanks 2 are connected to a distributor 27 via the fuel supply lines 7 for filling the fuel gas tanks 2 with fuel gas. In order to promote a fast and even filling of the differently sized fuel gas tanks 2, the respective tank size should be taken into account when designing the non-return valves 8 arranged in the fueling path 7. This can be easily realized with the aid of the throttle and stop element 17 in a valve assembly 1 according to the invention. The throttle and stop element 17 is selected-depending on the tank size-from a modular system comprising a plurality of throttle and stop elements 17 having a different throttle cross-section A and/or a different height dimension h. The tank-specific design of the non-return valve 8 then only requires replacement of the throttle and stop element 17.

1. A valve assembly (1) for a fuel gas tank (2), comprising: a housing (3) in which a refueling path (7) having an integrated non-return valve (8) is formed, wherein the non-return valve (8) comprises an axially movable valve element (11) and a closing spring (9), a spring force of the closing spring (9) acts on the valve element (11) in a direction of a valve seat (10),
wherein, in a region of the non-return valve (8), a throttle and stop element (17) is integrated which has a defined throttle cross-section (A) for setting a gas mass flow in the refueling path (7) and a defined height dimension (h) for setting a lift (H) of the valve element (11).

2. The valve assembly (1) according to claim 1, wherein the throttle and stop element (17) is arranged in a refueling direction downstream of the valve element (11) of the non-return valve (8).

3. The valve assembly (1) according to claim 1, wherein the defined throttle cross-section (A) is formed by at least one bore (18), groove, and/or recess (19) of the throttle and stop element (17).

4. The valve assembly (1) according to claim 1,
wherein the throttle and stop element (17) is inserted, into the housing (3) of the valve assembly (1), and has an end face (20) facing the valve element (11) serving as a lift stop (12).

5. The valve assembly (1) according to claim 1,
wherein the throttle and stop element (17) is inserted, into the valve element (11) at least in sections and has an end face (21) facing away from the valve element (11), which cooperates with a housing-side lift stop (12).

6. The valve assembly (1) according to claim 1,
wherein the throttle and stop element (17) are arranged in a stepped fashion.

7. The valve assembly (1) according to claim 1,
wherein the throttle and stop element (17) have at least one outer circumferential flat section (23).

8. The valve assembly (1) according to claim 1,
wherein the housing (3) has a connection portion (3.1) for connection to the fuel gas tank (2) and a connection portion (3.2) for connection to at least one high-pressure connection line (15).

9. A fuel gas tank (2) having a valve assembly (1) according to claim 1.

10. A fuel gas tank system comprising at least one fuel gas tank (2) having a valve assembly (1) according to claim 1.

11. The valve assembly according to claim 1, wherein the throttle and stop element (17) is in the housing (3) and/or in the valve element (11).

12. The valve assembly (1) according to claim 4, wherein the throttle and stop element (17) is pressed into the housing (3) of the valve assembly (1).

13. The valve assembly (1) according to claim 5, wherein the throttle and stop element (17) is pressed into the housing (3) of the valve assembly (1).

14. The valve assembly according to claim 7, wherein the at least one outer circumferential flat section (23) is in the form of a bevel.

15. The fuel gas tank according to claim 9, wherein the housing (3) of the valve assembly (1) is inserted into the fuel gas tank (2) in sections.

16. The fuel gas tank according to claim 15, wherein the housing (3) of the valve assembly (1) is screwed into the fuel gas tank (2) in sections.

17. The fuel gas tank according to claim 9, wherein the housing (3) of the valve assembly (1) is inserted into a bottle neck of the fuel gas tank (2).
